(19) United States
(12) Patent Application Publication
(10) Pub. No.: US 2025/0276577 A1
(43) Pub. Date: Sep. 4, 2025

(54) DISPLAY DEVICE

(71) Applicant: TOYOTA JIDOSHA KABUSHIKI KAISHA, Toyota-shi (JP)

(72) Inventor: Akito UCHIDA, Toyota-shi (JP)

(73) Assignee: TOYOTA JIDOSHA KABUSHIKI KAISHA, Toyota-shi (JP)

(21) Appl. No.: 18/958,530

(22) Filed: Nov. 25, 2024

(30) Foreign Application Priority Data
Mar. 4, 2024 (JP) 2024-032328

(51) Int. Cl. B60K 35/22

(52) U.S. Cl. CPC B60K 35/22

(57) ABSTRACT

The display device includes a display unit that displays an indicator of a shift timing at which a driver of the vehicle shifts the transmission, and a control unit that controls the display unit such that the indicator extends from the left end and the right end of the display area toward the center in the horizontal direction of the vehicle as the shift timing approaches.

### CROSS-REFERENCE TO RELATED APPLICATION

This application claims priority to Japanese Patent Application No. 2024-032328 filed on Mar. 4, 2024, incorporated herein by reference in its entirety.

### BACKGROUND

### 1. Technical Field

The present disclosure relates to a display device.

### 2. Description of Related Art

Regarding an in-vehicle display device, for example, Japanese Unexamined Patent Application Publication No. 2007-145240 (JP 2007-145240 A) describes that a shift timing indicator installed at a driver's seat rotates a pointer and notifies a driver about a shift timing when the pointer reaches the end of an index mark portion.

### SUMMARY

For example, during cornering of the vehicle, the field of view of the driver is narrower on one side depending on the cornering direction. Therefore, it is difficult to check the shift timing on the shift timing indicator.

In view of this, the present disclosure provides a display device capable of improving visibility of a shift timing.

The display device of the present disclosure includes:
a display unit configured to display an indicator of a shift timing at which a driver of a vehicle shifts a transmission; and
a control unit configured to control the display unit to extend the indicator from a left end and a right end of a display region toward a center in a horizontal direction of the vehicle as the shift timing approaches.

In the above display device,
the indicator may include a plurality of lighting regions that is arranged in the horizontal direction in the display region and is configured to be lit individually under control of the control unit, and
the control unit may be configured to control the display unit to light the lighting regions sequentially from the left end and the right end toward the center as the shift timing approaches, and to light all the lighting regions at the shift timing.

In the above display device,
the control unit may be configured to set, based on an instruction from a terminal device, a timing at which at least one of the lighting regions is lit.

In the above display device,
the control unit may be configured to control the display unit to extend the indicator toward the center each time the number of revolutions of an internal combustion engine of the vehicle increases and reaches each of a plurality of thresholds provided for gear stages of the transmission.

In the above display device,
the control unit may be configured to control the display unit to start extending the indicator from the left end and the right end toward the center at a timing earlier by a predetermined period than the shift timing.

According to the present disclosure, it is possible to improve the visibility of the shift timing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an example of a system of a vehicle;

FIG. 2 is a diagram (part 1) illustrating a display example of a screen of an in-vehicle display;

FIG. 3 is a diagram (part 2) illustrating a display example of a screen of an in-vehicle display;

FIG. 4 is a diagram illustrating an example of a rotation speed table;

FIG. 5A is a diagram illustrating an example of readjustment of the rotation speed threshold

FIG. 5B is a diagram illustrating an example of setting the rotation speed table in the gear continuous mode; and

FIG. 6 is a flowchart illustrating an example of a shift indicator display process.

### DETAILED DESCRIPTION OF EMBODIMENTS

### System Configuration of Vehicle

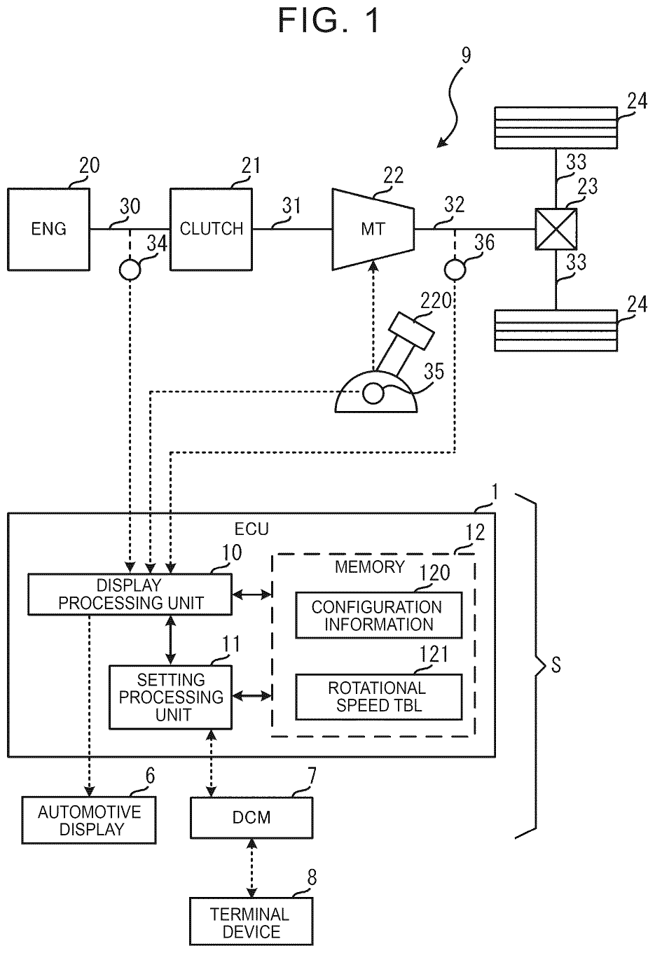

FIG. 1 is a configuration diagram illustrating an example of a system of a vehicle 9. The vehicle 9 includes an engine (ENG) 20, a clutch 21, a manual transmission (MT) 22, a shift lever 220, a differential gear 23, and drive wheels 24. The engine 20 is an example of an internal combustion engine. The engine 20 is, for example, a gasoline engine, but may also be a diesel engine. A clutch 21 is coupled to the crankshaft 30 of the engine 20.

The clutch 21 is provided between the engine 20 and the manual transmission 22. The clutch 21 is switched to an engaged state or a disengaged state in response to an operation of a clutch pedal (not shown). The output shaft 31 of the clutch 21 is connected to the input side of the manual transmission 22. Therefore, when the clutch 21 is in the engaged state, the driving force of the engine 20 is transmitted to the manual transmission 22.

The manual transmission 22 is an example of a transmission. The manual transmission 22 is provided in a power transmission path between the engine 20 and the drive wheels 24. The shift lever 220 is used for a shift operation of the manual transmission 22 by the driver. When the driver operates the shift lever 220, the gear stage of the manual transmission 22 is switched according to the shift position of the shift lever 220. The output shaft 32 of the manual transmission 22 is connected to a differential gear 23 which is a final reduction gear. The left and right axles 33 are connected to the differential gear 23. The driving force is transmitted from the output shaft 32 of the manual transmission 22 to the drive wheels 24 via the axles 33.

The vehicle 9 includes a crank angle sensor 34, a shift position sensor 35, a vehicle speed sensor 36, and a display device S. The display device S includes an ECU (Electronic Control Unit) 1, an in-vehicle display 6, and a data communication module (DCM) 7.

The crank angle sensor 34 detects the number of revolutions per unit time (rpm) of the engine 20 from the revolution angle of the crankshaft 30. The vehicle speed sensor 36 detects the speed of the vehicle 9 from the rotation angle of the output shaft 32. The shift position sensor 35 is provided in the shift lever 220 and detects a gear stage of the manual transmission 22. The crank angle sensor 34, the vehicle speed sensor 36, and the shift position sensor 35 respectively output the detected values to ECU 1.

ECU 1 is an exemplary control unit. ECU 1 is a computer including a CPU (Central Processing Unit) (not shown), a ROM (Read Only Memory), and a RAM (Random Access Memory). ECU 1 controls displaying of the in-vehicle display 6.

ECU 1 includes a display processing unit 10 and a setting processing unit 11, for example, as software functions for driving a CPU. Note that the display processing unit 10 and the setting processing unit 11 may be implemented by hardware such as IC (Integrated Circuit).

ECU 1 also includes a non-volatile memory 12, such as a flash memory. A setting information 120 and a rotational speed table (TBL) 121 are stored in the memory 12.

The display processing unit 10 outputs image information to the in-vehicle display 6. The in-vehicle display 6 is, for example, a liquid crystal display, and is disposed in front of a driver's seat of the vehicle 9. The in-vehicle display 6 displays an image based on image information from the display processing unit 10. As will be described later, an indicator (hereinafter, referred to as a shift indicator) of the shift timing at which the driver of the vehicle 9 operates the manual transmission 22 and the like are displayed on the in-vehicle display 6.

The setting processing unit 11 sets the rotational speed table 121 based on the setting information 120. In the rotational speed table 121, the rotational speed of the engine 20 indicating the lighting timings of the plurality of lighting regions of the indicator is set for each gear stage of the manual transmission 22. As will be described later, the setting information 120 includes information for setting the lighting timing of the lighting area.

The data communication module 7 includes wireless communication means such as an antenna, and is connected to a communication network (not shown) such as the Internet. The setting processing unit 11 communicates with the terminal device 8 on the communication network via the data communication module 7. The terminal device 8 is, for example, a smartphone carried by a driver or a passenger of the vehicle 9, but is not limited thereto, and may be a personal computer or a tablet terminal. The setting processing unit 11 can receive a setting change of the setting information 120 from the terminal device 8. The display processing unit 10 displays an indicator on the in-vehicle display 6 after receiving a notification of completion of setting of the rotational speed table 121 from the setting processing unit 11.

### Example of Screen Configuration of In-Vehicle Display

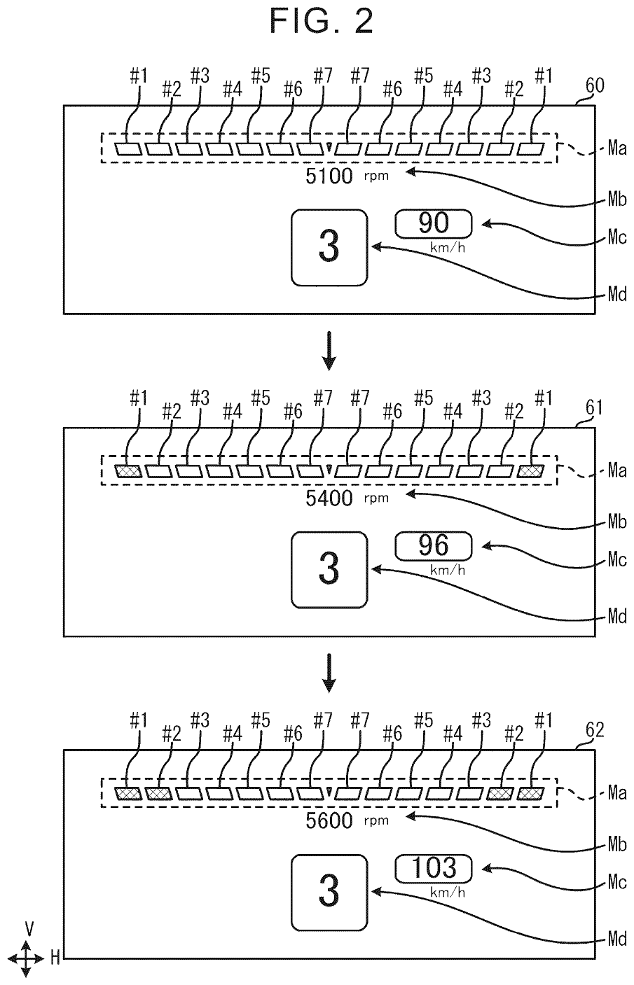

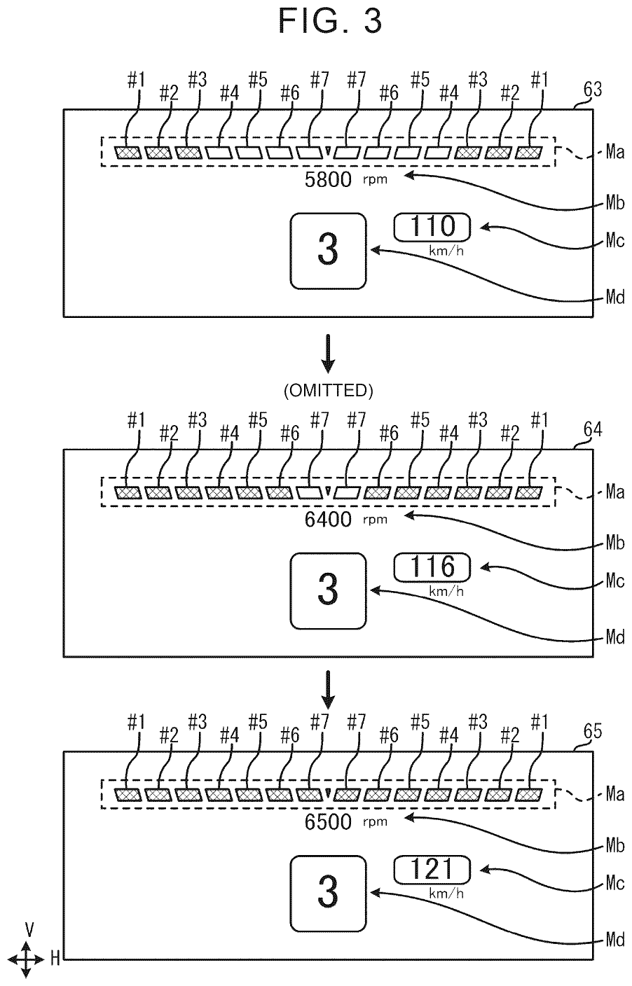

FIG. 2 and FIG. 3 are diagrams showing display examples of the screens 60 to 65 of the in-vehicle display 6. On the screens 60 to 65, a shift indicator Ma, a rotational speed meter Mb, a speed meter Mc, and a gear position indicator Md when the in-vehicle display 6 is viewed from the driver's seat are displayed. FIG. 2 and FIG. 3 show the horizontal direction H and the vertical direction V of the vehicle 9.

The display processing unit 10 generates images of the shift indicator Ma, the rotational speed meter Mb, the speed meter Mc, and the gear position indicator Md, and outputs the images to the in-vehicle display 6. The screens 60 to 65 show examples of changes in the display of the in-vehicle display 6 in time series when the vehicle 9 accelerates.

The shift indicator Ma is an exemplary indicator of the shift timing of the manual transmission 22. In FIG. 2 and FIG. 3, a dotted line frame indicating the shift indicator Ma is an exemplary displayed area. The shift indicator Ma extends from the left end and the right end of the display area toward the center as the shift timing approaches in the horizontal direction H of the vehicle 9, and reaches the center at the shift timing. This allows the shift indicator Ma to prompt the driver to shift at a timely shift timing.

The shift indicator Ma includes a set of lighting areas #1 to #7 that extend in the horizontal direction H in the display area and are arranged symmetrically with respect to the center thereof. Each of the lighting regions #1 to #7 has, for example, a substantially parallelogram shape and is arranged at a predetermined interval in the horizontal direction H. The display processing unit 10 can individually turn on or turn off the lighting areas #1 to #7 on the right side and the left side.

The lighting area #1 is arranged at the left end and the right end in the displaying area of the shift indicator Ma. In the center of the shift indicator Ma, two lighting areas #7 are arranged adjacent to each other. The other lighting regions #2 to #6 are arranged so as to be adjacent to each other from the respective lighting regions #1 at the left end and the right end toward the central lighting region #7.

The rotational speed meter Mb is disposed below the vertical direction V as viewed from the center of the shift indicator Ma in the horizontal direction H, and indicates the rotational speed of the engine. The display processing unit 10 acquires the rotational speed of the engine 20 from the crank angle sensor 34. The display processing unit 10 controls the in-vehicle display 6 so that the rotational speed of the engine 20 is displayed on the rotational speed meter Mb.

The gear position indicator Md is disposed below the rotational speed meter Mb in the vertical direction V and indicates the gear stage of the manual transmission 22. The display processing unit 10 acquires the gear stage of the manual transmission 22 from the shift position sensor 35. The display processing unit 10 controls the in-vehicle display 6 so that the gear stage is displayed on the gear position indicator Md. In the present example, the case where the gear stage of the manual transmission 22 is the third speed is illustrated.

The speed meter Mc is disposed below the shift indicator Ma in the vertical direction V and on the right side of the gear position indicator Md in the horizontal direction H, and indicates the vehicle speed of the vehicle 9. The display processing unit 10 acquires the vehicle speed of the vehicle 9 of the manual transmission 22 from the vehicle speed sensor 36. The display processing unit 10 controls the in-vehicle display 6 so that the vehicle speed is displayed on the speed meter Mc.

The display processing unit 10 controls the in-vehicle display 6 such that the respective lighting regions #1 to #7 are sequentially turned on from the left end and the right end in the horizontal direction H toward the center as the shift timing approaches. The display processing unit 10 controls the in-vehicle display 6 so that all of the lighting regions #1 to #7 are turned on at the shift timing. The display processing unit 10 refers to the rotational speed table 121 based on the rotational speed acquired from the crank angle sensor 34 to determine the lighting area to be turned on from the lighting areas #1 to #7.

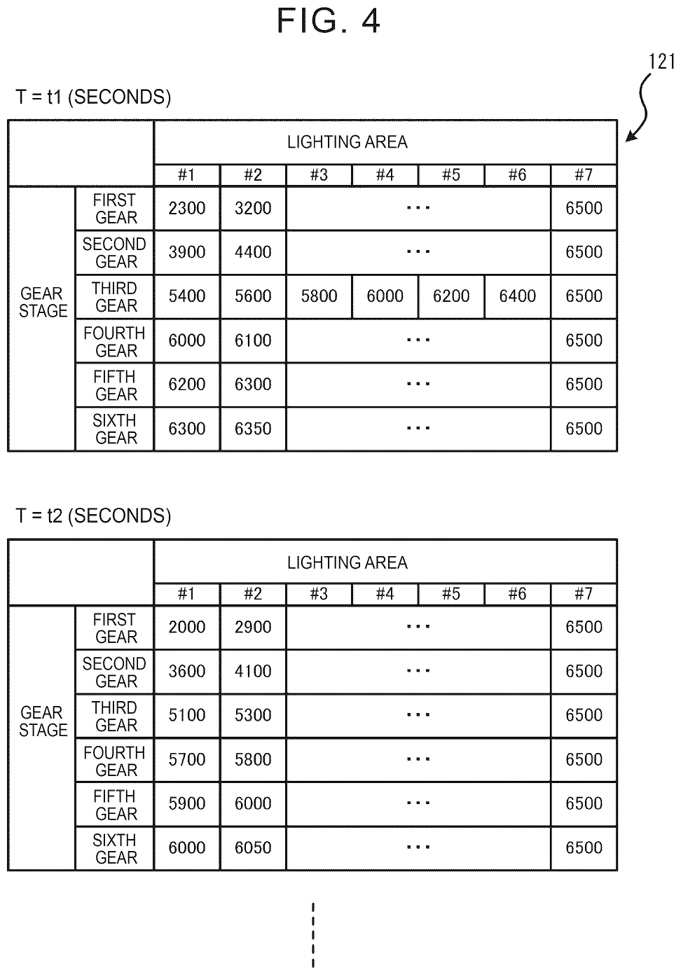

FIG. 4 is a diagram illustrating an example of the rotational speed table 121. In the rotational speed table 121, a threshold value of the rotational speed under which the left and right lighting areas #1 to #7 are turned on is set for each gear stage (for example, one to six speeds) of the manual transmission 22. The threshold value increases in the order of the lighting areas #1 to #7, and increases as the gear stage increases.

The display processing unit 10 controls the in-vehicle display 6 based on the rotational speed table 121 so that only the lighting region satisfying the engine rotation speed≥threshold is turned on in the lighting regions #1 to #7. The setting processing unit 11 sets each threshold value of the rotational speed of the rotational speed table 121 based on the setting information 120.

The setting information 120 includes the shift rotation speed and the lighting mode. The shift rotational speed is the rotational speed of the engine 20 when the driver performs a shift operation (upshift) on the manual transmission 22. When the rotational speed of the engine is equal to or higher than the shift rotational speed, the display processing unit 10 turns on the two lighting areas #7 in the center of the shift indicator Ma. Therefore, the setting processing unit 11 sets the shift rotation speed of the setting information 120 to the threshold value of the lighting area #7 of the rotational speed table 121.

In the lighting mode of the setting information 120, one of the “time mode” and the “gear continuous mode” in which the lighting conditions of the left and right lighting areas #1 are different is selectively set. In the “time mode”, the lighting timing of the lighting area #1 can be set T seconds before the shift timing. Here, the time T seconds can be selected from a plurality of predetermined times t1, t2, . . . , tn (n: positive integer), for example. Further, in the “gear continuous mode”, the lighting timing of the lighting region #1 can be set to the timing shifted up from the immediately preceding gear stage. In the present example, the “time mode” is taken as an example, and the “gear continuous mode” will be described later.

As described above, the setting processing unit 11 sets the shift rotation speed of the setting information 120 to the threshold value of the lighting area #7 of the rotational speed table 121. For example, when the shifting rotational speed is 6500 rpm, 6500 rpm is set as the threshold of the lighting area #7 of all gear stages. In this example, the shift rotation speed is set to a set value common to all gear stages, but the shift rotation speed may be individually set for each gear stage.

In the “time mode”, the display processing unit 10 turns on each of the left and right lighting areas #1 T seconds before the shift timing. In the “time mode”, the display processing unit 10 turns on the lighting areas #2 to #6 in the order toward the center side as the number of revolutions increases, and turns on the two lighting areas #7 in the center at the shift timing. Therefore, the setting processing unit 11 sets the threshold value of the lighting area #1 for each gear stage from the time change of the rotational speed when the rotational speed reaches the shift rotational speed after T seconds based on the output of the engine 20 when the accelerator (not shown) is fully opened. For example, the threshold value of the lighting area #1 of the rotational speed table 121 when T is t1 seconds is larger than the threshold value of the lighting area #1 of the same gear stage of the rotational speed table 121 when T is t2 seconds (>t1).

Further, the setting processing unit 11 sets the respective thresholds of the lighting areas #2 to #6 so that the lighting areas #2 to #6 of the respective gear stages are turned on at regular time intervals based on the time change of the above-described rotational speed, the threshold value of the lighting area #1, and the threshold value of the lighting area #7 (shift rotational speed). The respective thresholds of the lighting areas #2 to #6 may be set using map data generated from experimental results such as acceleration performance of the vehicle 9 and simulated results and stored in ROM of ECU 1 in advance.

Referring again to FIGS. 2 and 3, an example of the lighting operation of the lighting regions #1 to #7 will be described. In the present embodiment, the case where the gear stage of the manual transmission 22 is the third speed in the “time mode” of T=t1 seconds is exemplified, but the lighting operation is performed in the same manner as below even in the case where the time T seconds is set to another time or in the case where the gear stage is the shift position other than the third speed. In FIG. 2 and FIG. 3, the lighting regions #1 to #7 in the lighting state are indicated by shading.

Screen 60 shows a state in which all lighting areas #1 to #7 are turned off. At this time, since the rotational speed of the engine is smaller than the threshold values of the three-speed lighting areas #1 to #7 of the rotational speed table 121, the display processing unit 10 controls the in-vehicle display 6 so that all the lighting areas #1 to #7 are turned off.

The screen 61 shows a state in which only the lighting area #1 is lit. At this time, the rotational speed of the engine reaches 5400 rpm which is a threshold value of the three-speed lighting area #1 of the rotational speed table 121, but is smaller than the threshold value of the three-speed lighting area #2. Therefore, the display processing unit 10 controls the in-vehicle display 6 so that only the lighting area #1 is turned on.

By confirming the lighting of the lighting area #1, the driver can know that the shift timing is close and prepare for the shift operation. As described above, since the time T seconds can be set from the terminal device 8 in the “time mode”, the driver can determine the lighting timing of the lighting region #1 in accordance with the driver's own driving capability.

Next, the screen 62 shows a state in which only the lighting areas #1 and #2 are lit. At this time, the rotational speed of the engine reaches 5600 rpm which is a threshold value of the three-speed lighting area #2 of the rotational speed table 121, but is smaller than the threshold value of the three-speed lighting area #3. Therefore, the display processing unit 10 controls the in-vehicle display 6 so that only the lighting areas #1 and #2 are turned on.

Next, the screen 63 shows a state in which only the lighting areas #1 to #3 are lit. At this time, the rotational speed of the engine reaches 5800 rpm which is a threshold value of the three-speed lighting area #3 of the rotational speed table 121, but is smaller than the threshold value of the three-speed lighting area #4. Therefore, the display processing unit 10 controls the in-vehicle display 6 so that only the lighting areas #1 to #3 are turned on. Thereafter, although not shown, the display processing unit 10 controls the in-vehicle display 6 so that the lighting area #4 is further turned on when the rotation speed reaches the threshold value of the three-speed lighting area #4, and the lighting area #5 is further turned on when the rotation speed reaches the threshold value of the three-speed lighting area #5, as described above.

Next, the screen 64 shows a state in which only the lighting areas #1 to #6 are lit. At this time, the rotational speed of the engine reaches 6400 rpm equal to or greater than the threshold value of the three-speed lighting area #6 of the rotational speed table 121, but is smaller than the threshold value of the three-speed lighting area #7, that is, the shifted rotational speed. Therefore, the display processing unit 10 controls the in-vehicle display 6 so that only the lighting areas #1 to #6 are turned on.

Next, a screen 65 shows a state in which all the lighting areas #1 to #7 are lit. At this time, since the rotational speed of the engine has reached 6500 rpm which is the threshold of the three-speed lighting area #7 of the rotational speed table 121, the display processing unit 10 controls the in-vehicle display 6 so that all the lighting areas #1 to #7 are turned on. The driver can perform the shift operation while knowing the arrival of the shift timing by checking the lighting of all the lighting areas #1 to #7. Here, the display processing unit 10 may blink all the lighting areas #1 to #7 so that the driver can easily notice the arrival of the shift timing.

As described above, the display processing unit 10 controls the in-vehicle display 6 such that the shift indicator Ma extends from the left end and the right end toward the center as the shift timing approaches in the horizontal direction H of the vehicle 9. Therefore, the driver of the vehicle 9 can confirm the shift timing by looking at only one of the right and left regions of the shift indicator Ma. Therefore, even when the driver's field of view narrows while the vehicle 9 is cornering, either the right side or the left side of the in-vehicle display 6, the driver can easily check the shift timing. Therefore, the display device S can improve the visibility of the shift timing.

As described above, the display processing unit 10 controls the in-vehicle display 6 to turn on the respective lighting areas #1 at the left end and the right end of the shift indicator Ma T seconds prior to the shift timing. As a result, the shift indicator Ma starts to extend from the left end and the right end toward the center T seconds prior to the shift timing. Therefore, the driver can prepare the shift lever 220 for the shift operation by visually recognizing that the shift indicator Ma has started to extend.

In addition, as described above, when the rotational speed of the engine 20 is equal to or greater than the threshold value of the corresponding gear stage of the rotational speed table 121, the display processing unit 10 controls the in-vehicle display 6 so that the lighting areas #1 to #7 corresponding to the threshold value are turned on. As a result, each time the rotational speed of the engine 20 is increased and reaches the respective thresholds provided for each gear stage of the manual transmission 22, the shift indicator Ma extends toward the center. Therefore, when the vehicle 9 is accelerated, the shift indicator Ma extends at a pace corresponding to the gear stage, and thus the driver can feel the comfort of the acceleration more strongly than when the shift indicator Ma extends at a uniform pace that is not dependent on the gear stage.

The display processing unit 10 controls the in-vehicle display 6 such that the lighting regions #1 to #7 are sequentially turned on from the left end and the right end toward the center as the shift timing approaches, and all of the lighting regions #1 to #7 are turned on at the shift timing. Therefore, the driver can clearly feel the approach of the shift timing as compared with the case where the shift indicator Ma is not divided into the lighting areas #1 to #7. Note that, in the present example, the lighting regions #1 to #7 are individually turned on, but two or more lighting regions #1 to #7 adjacent to each other may be turned on substantially simultaneously. In this case, the setting processing unit 11 sets the rotational speed table 121 so that the threshold values of the lighting areas #1 to #7 that are simultaneously turned on have the same value.

Further, the setting processing unit 11 changes the setting information 120 based on an instruction from the terminal device 8. For example, the setting processing unit 11 can change the shift rotation speed from the initial value in accordance with the instruction, change the lighting mode to the “time mode”, and then change the time T seconds from the initial value. Therefore, the setting processing unit 11 can set the lighting timing of the lighting area #1 by changing the shift rotation speed, and set the lighting timing of the lighting area #1 by changing the time T seconds. Further, the setting processing unit 11 may update each threshold value of the rotational speed table 121 based on an instruction from the terminal device 8.

As described above, the setting processing unit 11 sets the timing at which at least one of the lighting regions #1 to #7 is turned on based on the instruction from the terminal device 8. As a result, for example, the lighting timing of the lighting area #1 can be adjusted in accordance with the driving technique of the driver, and thus the convenience is improved.

### Readjustment of Threshold

The setting processing unit 11 sets the shift rotation speed of the setting information 120 to the threshold value of the lighting area #7 of the rotational speed table 121 and sets the respective threshold values of the other lighting areas #1 to #6 in accordance with the shift rotation speed with respect to the rotational speed table 121. When an instruction to change the shift rotation speed is received from the terminal device 8, the setting processing unit 11 calculates a difference between the initial value of the shift rotation speed and the change value, and changes each threshold value of the rotational speed table 121 in accordance with the difference.

For example, when at least one of the changed thresholds falls below the engine 20 idling speed R_idle (hereinafter referred to as “idling speed”), the setting processing unit 11 readjusts the respective thresholds so that the lighting areas #1 to #7 corresponding to the changed thresholds do not turn on due to idling.

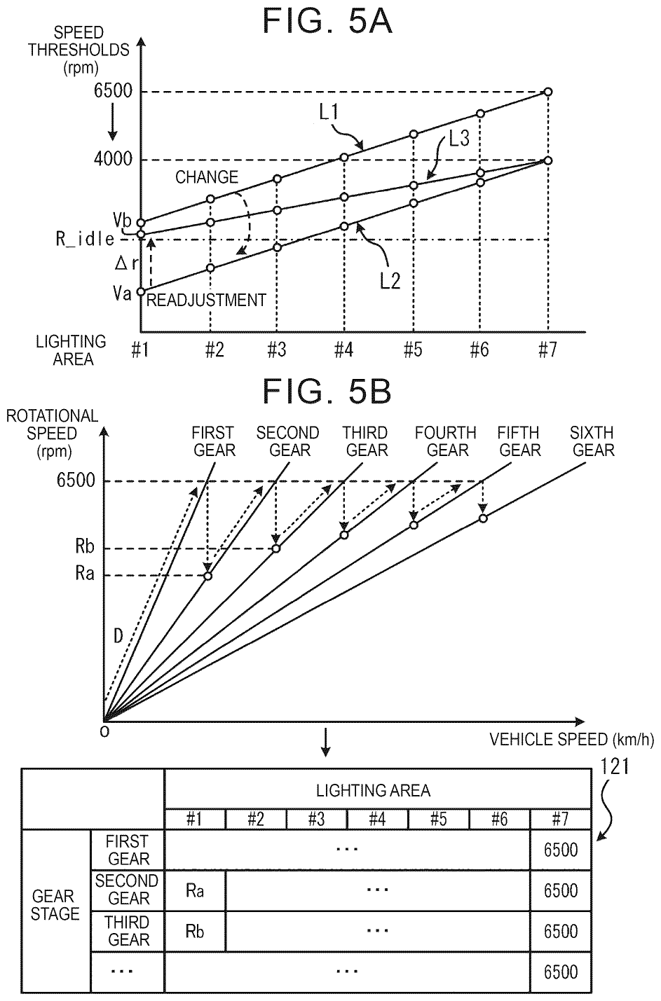

FIG. 5A is a diagram illustrating an example of readjustment of the threshold value of the rotation speed. In FIG. 5A, the horizontal axis represents the lighting areas #1 to #7, and the vertical axis represents the thresholds (rpm) of the rotational speeds. The code L1 indicates an initial value, and the code L2 indicates a changed threshold (changed value) according to an instruction from the terminal device 8. The code L3 indicates thresholds after readjustment.

In the present embodiment, the default value of the threshold value (shifting rotational speed) of the lighting area #7 is set to 6500 (rpm), and the changed value is set to 4000 (rpm). Since the difference between the initial value and the changed value is 2500 (rpm), the setting processing unit 11 changes the changed value to a changed value smaller than the initial value by 2500 (rpm) than the other lighting areas #1 to #6.

At this time, for example, it is assumed that the change value of the lighting areas #1 to #3 is lower than the idle rotation speed R_idle. On the other hand, the setting processing unit 11 readjusts the thresholds of the lighting area #1 by adding the adjusting value Δr to the changed value Va of the lighting area #1. Here, the setting processing unit 11 calculates the adjusted value Δr by adding a predetermined value to the difference between the changed value Va of the lighting area #1 and the idle rotational speed R_idle, for example.

Further, the setting processing unit 11 readjusts the change values of the lighting areas #2 to #6 so that the change values of the other lighting areas #2 to #6 increase at equal intervals toward the change value of the lighting area #7 between the threshold Vb of the lighting area #1 after readjustment and the change value (4000 (rpm)) of the lighting area #7. As a result, all the threshold values are readjusted so as to exceed the idle rotation speed R_idle, so that the lighting of the lighting regions #1 to #7 is suppressed during the idling of the engine 20.

### Gear Continuous Mode

When the lighting mode of the setting information 120 is set to the gear continuous mode, the setting processing unit 11 sets the threshold value of the number of revolutions of the lighting region #1 of each gear stage so that the vehicle speeds of the gear stages before and after the shift-up of the manual transmission 22 are substantially the same.

FIG. 5B is a diagram illustrating an example of the setting of the rotational speed table 121 in the gear continuous mode. FIG. 5B illustrates a change characteristic of the rotational speed of the engine 20 with respect to the vehicle speed of the vehicle 9 and a rotational speed table 121 in the gear continuous mode. In this embodiment, it is assumed that the shifting rotational speed is 6500 (rpm).

A plurality of dotted arrows D in the change characteristic of the rotational speed indicate an example of the change of the rotational speed in the case where the gear stage of the manual transmission 22 is continuously shifted up from the first speed to the sixth speed. Since the vehicle speeds before and after the upshift are substantially the same, the setting processing unit 11 sets the rotation speed corresponding to the vehicle speed to the threshold value of the lighting area #1 for the gear stage after the upshift. For example, when the rotational speed immediately after the gear stage shifts up from the first speed to the second speed is set as Ra, the setting processing unit 11 sets Ra to the thresholds of the second-speed lighting area #1 of the rotational speed table 121.

Further, for example, when the rotational speed immediately after the gear stage shifts up from the second speed to the third speed is set to Rb (>Ra), the setting processing unit 11 sets Rb to the thresholds of the three-speed lighting area #1 of the rotational speed table 121. The setting processing unit 11 sets, for example, the rotational speed at which the lighting regions #2 to #6 are sequentially turned on at substantially constant time intervals to the threshold values of the lighting regions #2 to #6 of the respective gear stages of the rotational speed table 121, based on the respective threshold values of the lighting regions #1 and #7 and the output of the engine 20 at the time of full opening of the accelerator.

Thus, when the gear stage of the manual transmission 22 is shifted up, each of the lighting areas #2 to #7 other than the lighting area #1 is turned off, and thereafter, the lighting area #2 to the lighting area #7 are sequentially turned on with an increase in the number of revolutions. Therefore, when the driver continuously shifts up the gear stage of the manual transmission 22 from the first speed to the seventh speed, the lighting areas #1 to #7 are repeatedly and sequentially turned on, so that a refreshing feeling can be obtained.

When the shift rotation speed is changed in accordance with an instruction from the terminal device 8, the setting processing unit 11 changes the threshold values of the lighting areas #1 to #7 of the gear stages of the rotational speed table 121 based on the ratio of the rotation speeds before and after the change. For example, when the shifting speed is changed from 7200 (rpm) to 6100 (rpm), the setting processing unit 11 also changes the thresholds of the lighting area #7 from 7200 (rpm) to 6100 (rpm). When the threshold value prior to the change of the lighting area #1 is 3500 (rpm), the setting processing unit 11 changes the threshold value of the lighting area #1 from 3500 (rpm) to 2965 (rpm) (≈3500×6100/7200).

### Shift Indicator Display Processing

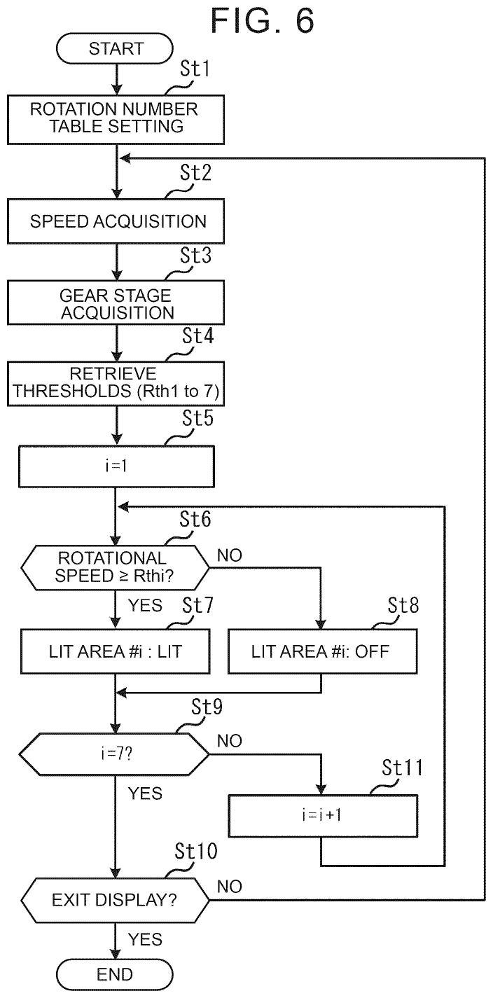

FIG. 6 is a flow chart illustrating an exemplary process of displaying shift indicator Ma. First, the setting processing unit 11 sets the rotational speed table 121 based on the setting information 120 (St1). Here, when an instruction is received from the terminal device 8, the setting information 120 changes the setting information 120 based on the instruction before setting the rotational speed table 121.

Next, the display processing unit 10 obtains the rotational speed of the engine 20 from the crank angle sensor (St2), and obtains the gear stage of the manual transmission 22 from the shift position sensor 35 (St3). Next, the display processing unit 10 acquires Rth7 from the thresholds Rth1 corresponding to the gear stages from the rotational speed table 121 (St4).

Next, the display processing unit 10 sets “1” to the variable i (=1, 2, . . . , 7) for identifying the lighting areas #1 to #7 (St5). Next, the display processing unit 10 compares the rotational speed with the threshold-value Rthi (St6). When the rotational speed≥Rthi is satisfied (Yes of St6), the display processing unit 10 turns on the lighting area #i (St7). When the rotational speed<Rthi is satisfied (No of St6), the display processing unit 10 turns off the lighting area #i (St8).

Next, the display processing unit 10 determines whether the variable i is “7” (St9). When the variable i is not “7” (No of St9), the display processing unit 10 adds “1” to the variable i (St11), and executes the respective processing after St6.

When the variable i is “7” (Yes of St9), the display processing unit 10 determines whether to end the display of the shift indicator Ma (St10). When the indication is not finished (No in St10), the processes after St2 are executed again. In addition, when the display is terminated due to, for example, the power of the in-vehicle display 6 being turned off (Yes of St10), this process is terminated. In this way, the process of displaying the shift indicator Ma is executed.

Although the manual transmission 22 has been described as the transmission in the present embodiment, the above-described display device S can be used in the case of an automatic transmission as long as the vehicle has a paddle shift function for switching gear stages, for example. In addition, the lighting color of each of the lighting areas #1 to #7 may be the same or different. For example, the lighting regions #1 to #4 may be green, the lighting regions #5 and #6 may be red, and the lighting region #7 may be blue.

The embodiments described above are examples of preferred embodiments of the present disclosure. However, the present disclosure is not limited to this, and various modifications can be made without departing from the gist of the present disclosure.

What is claimed is:

1. A display device comprising:
a display unit configured to display an indicator of a shift timing at which a driver of a vehicle shifts a transmission; and
a control unit configured to control the display unit to extend the indicator from a left end and a right end of a display region toward a center in a horizontal direction of the vehicle as the shift timing approaches.

2. The display device according to claim 1, wherein:
the indicator includes a plurality of lighting regions that is arranged in the horizontal direction in the display region and is configured to be lit individually under control of the control unit; and
the control unit is configured to control the display unit to light the lighting regions sequentially from the left end and the right end toward the center as the shift timing approaches, and to light all the lighting regions at the shift timing.

3. The display device according to claim 2, wherein the control unit is configured to set, based on an instruction from a terminal device, a timing at which at least one of the lighting regions is lit.

4. The display device according to claim 1, wherein the control unit is configured to control the display unit to extend the indicator toward the center each time the number of revolutions of an internal combustion engine of the vehicle increases and reaches each of a plurality of thresholds provided for gear stages of the transmission.

5. The display device according to claim 1, wherein the control unit is configured to control the display unit to start extending the indicator from the left end and the right end toward the center at a timing earlier by a predetermined period than the shift timing.
